(19) United States
(12) Patent Application Publication
(10) Pub. No.: US 2011/0295617 A1
(43) Pub. Date: Dec. 1, 2011

(54) OPHTHALMOLOGIC INFORMATION MANAGEMENT SYSTEM

(76) Inventor: Craig Berger, Tampa, FL (US)

(21) Appl. No.: 12/956,134

(22) Filed: Nov. 30, 2010

Related U.S. Application Data
(63) Continuation of application No. 11/999,709, filed on Dec. 6, 2007, now abandoned.
(60) Provisional application No. 60/875,259, filed on Dec. 15, 2006.

(51) Int. Cl. G06Q 50/00

(52) U.S. Cl. 705/3

(57) ABSTRACT

Provided is a method for the management of a patient's ophthalmic information which enables eyecare professionals, particularly ophthalmologists, to obtain, with a patient's consent, a patient's latest optical data, including that derived from prior ophthalmological surgical procedures. Subsequent surgical procedures, performed using such data and surgical parameters calculated therefrom, can give results having increased effectiveness.

### RELATED APPLICATIONS

This application is a continuation of U.S. patent application Ser. No. 11/999,709, filed Dec. 6, 2007, now pending, which claims the benefit of U.S. provisional patent application Ser. No. 60/875,259, filed Dec. 15, 2006, now expired.

### TECHNICAL FIELD

The present invention pertains to the entering, storage, management and accessing of ophthalmologic information such as pre-surgical, surgical and post-surgical ophthalmologic measurements, as well as to calculations and manipulations based on the data.

### BACKGROUND INFORMATION

Vision problems due to refractive error (nearsightedness, farsightedness and astigmatism) affect more than 50% of the population.¹ Within the last ten years, however, new medical procedures have been developed which can reverse or compensate for the geometrical and other changes which occur in the human eye with age, damage, or simply because of prone genetics. Some of these procedures, known collectively as “corneal refractive procedures,” can, in many cases, restore perfect vision, or even create perfect vision for those who have never had it. Some of the present procedures which have improved the sight for many are performed with a laser. Examples of such procedures are LASIK (laser-assisted in situ keratomileusis), LASEK (laser epithelial in situ keratomileusis), PRK (photorefractive keratectomy) and EPI-LASEK. In the United States, millions of such operations, collectively known as “laser refractive surgeries,” have been completed since first approved by the Food and Drug Administration in 1995. Other cornea refractive procedures such as CK (conductive keratoplasty) and cornea inlays have been developed or are in research trials. There are hundreds, if not thousands, of ophthalmologists performing the above procedures today. Prevalence of Refractive Error in the United States, 1999-2004, Susan Vitale, PhD, MHS; Leon Ellwein, PhD; Mary Frances Cotch, PhD; Frederick L. Ferris III, MD; Robert Sperduto, MD Arch Ophthalmol. 2008; 126(8):1111-1119.

Cornea refractive surgeries are common, safe, and effective procedures. However, few ophthalmologists take the time to explain to patients the long term issues involved with refractive vision correction. In fact, in many cases, refractive vision correction can impact a patient's future ophthalmologic care and vision.

Many vision problems arise in the young and middle-aged due to changes in the geometry of the optics of the eye. In particular, the shape and profile of the cornea can change with age. Corneas having profiles which are too steep or too flat can result in an image focal point that is in front of or behind the retina, respectively giving rise to blurred vision. Asymmetric (astigmatic) corneas result in a blurred image on the retina. Abnormally short eyes result in an image focal point behind the retina, while abnormally long eyes give a focal point in front of the retina.

“Steep” refers to high curvature of cornea measured in Diopters and given the unit “K” For example a normal cornea has a K value around 44 K, a flat 38 K and steep 50 K. The front surface has +K value, the posterior −K. K values of the cornea is the summation of the two and are always positive in value. Focal length is a variable determined by the combined K value of the cornea and the crystalline lens which has refractive properties (K for a typical cornea is around 44 and 19 for a crystalline lens). The focal length is independent of the anterior-posterior length of the eye, termed “axial length”. Astigmatism is a factor of the cornea and sometimes the crystalline lens and is also independent of the axial length. Astigmatism is irregularity in the shape of the cornea and/or lens. The basketball/football analogy can be used to describe astigmatism. If the cornea is round and symmetric like a basketball, there is no astigmatism. If the cornea is shaped more like a football where there is a flat axis and a steep axis but the cornea is still symmetrical, there is astigmatism present. The shape and profile of the cornea can change with age but once patients reach their twenties it tends to remain stable. Accommodation is the term used to describe the ability of the human crystalline lens to change shape/steepness and thus increase K values allowing a person to seamlessly focus from distance to near. Presbyopia is the progressive loss of accommodation which often begins around the age of 40 and progressively restricts/impairs near vision. Current research in cornea laser refractive surgery may give the cornea multifocality (similar to multifocal contacts and multifocal intraocular lenses after cataract surgery).

Refractive vision correction techniques take advantage of the fact that the cornea provides a significant amount of the focusing of light required for vision. Adjustments to the thickness and curvature of the cornea can be performed as needed in order to cause light to focus at the surface of the retina, rather than other points in space such as in front of the retina or behind it. As a result, vision is often dramatically improved. Furthermore, because the cornea is at the surface of the eye, it is easily accessed, eliminating the need for invasive procedures. The surgical correction strategy is to correct vision by altering the thickness and curvature of the cornea through ablation of the corneal tissue, the insertion of optical inlays, making radial (Radial Keratotomy/RK) or tangential incisions (Astigmatic keratotomy/AK) or focal heating at the surface of the eye, causing the focus of the eye optics to fall upon the retina.

Such procedures have been tremendously successful in correcting vision problems caused by refractive errors. However, the procedures can create problems for a patient later in the course of their lives. Because cornea refractive procedures permanently alter the shape and thickness of the cornea, ratio of front to back cornea curvature, eye pressure measurements, which are commonly taken at the surface of the cornea, will likely be inaccurate. Such pressure measurements and their change with time are critical to the screening, diagnosis and treatment of glaucoma. In particular, the measurements may be lower than actual, giving the ophthalmologist the impression that a patient is not at risk for glaucoma, when in reality, the patient may have glaucoma, or at least be at risk for the condition.

Similarly, if a patient develops cataracts which require surgical removal, it is important to know the changes in the cornea which have taken place due to a prior cornea refractive procedure. The development of cataracts in the lens of the eye is a ubiquitous problem associated with age. Surgery for the treatment of cataracts involves the replacement of a cataract-clouded crystalline lens with a synthetic lens (IOL, or intraocular lens), generally of a clear synthetic material which is similar in its properties to the natural lens, but differs significantly as well. For instance, the index of refraction of the IOL is different than that of the natural lens, thus allowing the use of an IOL which is thinner than the natural lens. However, because the IOL is not simply a substitution of the natural lens with a lens of the same dimensions and index of refraction, it is necessary to know the degree to which the light entering the eye is converged prior to its impingement upon the lens. Current formulas for calculating IOL focal power use the curvature of the anterior surface of the cornea and the axial length of the eye. Such formulas generally presume a constant relationship between the anterior and posterior surface curvatures of the cornea. After cornea refractive surgery, which generally affects the anterior surface of the cornea, the ratio is variably and permanently altered according to the degree of correction required. IOL calculations failing to account for the correction will be incorrect. In addition most cornea refractive procedures modify only the central cornea curvature, leaving the peripheral cornea untouched, giving an additional source of inaccuracies in IOL calculations. It is essential to know the degree to which the curvature and thickness of the cornea has been changed by the prior refractive corneal surgery because the changes must be compensated for in the calculation of the parameters of the IOL. Accurate calculations for glaucoma screening and treatment or cataract surgery require information about the characteristics of a patient's cornea before laser surgery, the exact type of surgery performed and the condition of the cornea immediately after surgery.

The condition of the patient after surgery is important because with time, the human crystalline lens will change refractive power due to thickening and changing protein and water content. Such changes can cause a patient to become hyperopic, myopic or astigmatic (lenticular astigmatism). One of the formulas for post lasik IOL calculation utilizes the change in refraction after lasik surgery. Since aging often results in refractive changes in the human crystalline lens, 1 month post-lasik refraction gives the most accurate result. The use of a refraction 10-20 years post lasik may be inaccurate due to the accumulation of enough lenticular (human crystalline lens) refractive change to throw off the IOL calculation.

If the ophthalmologist performing the cataract extraction and lens replacement or other surgery fails to take into account the corneal changes introduced by prior vision correction surgeries, the operation may actually reverse some of the benefits of the prior corneal vision correction. The surgeon may fail to select the correct IOL power and post-operation, the patient will be nearsighted or farsighted.

However, it is often difficult to locate the information years after the initial surgery. Patients may simply forget the identity of the doctor or surgery center where the surgery was performed. This is especially possible due to the outpatient, high-volume, quick recovery nature of corneal ablation operations. The long period of time between the typical age of refractive surgery and the development of cataract and/or glaucoma increases the risk of loss of surgical data. The surgery center may go out of business or the surgeon may retire. Furthermore physicians are only required to maintain patient records for 5-7 years depending on different state laws. To date, however, there is no reliable means for managing preoperative, operative, and postoperative ocular information and making it readily available for use by existing or future physicians.

While the effect of corneal modifications on subsequent lens replacement surgeries has been known for many years, locating the information from prior corneal refractive surgery is enough of an issue that it is often necessary to resort to difficult and expensive measures to measure the needed information before the subsequent lens replacement surgery. Even so, historical information is the most effective for accurately determining the IOL parameters and intraocular pressure (IOP).

### SUMMARY OF THE INVENTION

The present invention is a reliable, secure means for 1) enabling a patient or a physician, of the patient's choosing, to record the patient's ocular data, and in particular, the patient's surgical and post-surgical ocular data; 2) enabling the management of a patient's ocular information and history; and 3) enabling the selective retrieval, by a patient or a physician of the patient's designation, of the patient's data for subsequent use by the patient and, in particular, by the physician. As illustrated in FIGS. 1-2, in one embodiment of the present invention, a system 10 is disclosed for managing information comprising information pertaining to 1) the characteristics of a patient's eye prior to a cornea refractive surgery, 2) types of prior surgeries performed, and 3) the postoperative state of the cornea. The present system 10 allows a physician to more accurately perform calculations necessary for successfully performing subsequent eye procedures, such as, for example, cataract surgery. The system 10 of FIG. 1 illustrates the present invention, including the internet based platform, such as a website.

As illustrated in FIG. 1, the present invention can be utilized by a patient and/or a physician, as shown in steps 14 and 44. A patient can manage information regarding their eye characteristics prior to a corneal refractive surgery by accessing a patient portal link in step 14. This link directs the patient to a disclaimer page including legal disclaimers applicable to the patient.

If the patient consents to the legal disclaimers, the patient is directed through patient portal 22 to a page for creating a new account 24. Creation of a new account 24 comprises provision, by the patient, of identification and payment information via a sign-up form, which is directly or indirectly accessible from new account page 24. In particular, the patient inputs information comprising the patient's name, a functioning email address corresponding to the patient, and, optionally, one or more of the following: phone number, form of payment, billing address, and a security question answer. Patient also indicates agreements to the terms of service. In one embodiment, the consent is obtained on the sign up screen. In other embodiments, a consent screen is directly or indirectly linked with the sign up screen. In one embodiment, the terms of service can be accessed from the screen requiring agreement to terms of service.

System 10 stores the account information in a database and displays it at step 32 to a site administrator within a site administrator portal 100. Once payment information has been entered, the site administrator approves the account at new account approval step 36. After approval by the site administrator, the system 10 generates a pre-formatted email to the patient in step 40, sent to the email address provided at sign up. This email includes all login information necessary to login to the system 10 and begin entering data. Once the patient receives this information, the patient can login and enter ocular data, including data such as that mentioned above, which can be used by a physician in calculating parameters of future surgical operations.

As illustrated in FIGS. 1 and 2, a patient can input surgical, pre-surgical and post-surgical data into a form 64. In particular, this includes the information set forth in sample patient record 64, shown in detail in FIG. 2. Patient records can also be edited as necessary, as shown in step 84. Additionally, patient records can be supplemented with information relating to additional follow-up or touch-up surgical procedures.

Once a patient's records are created, they can be accessed as necessary by the patient or an authorized physician. In particular, the records can be used as historical information necessary for subsequent procedures, including cataract surgery and IOP calculations.

As noted above, a physician can also use the system 10, as illustrated in steps 44-78. A single physician can input and retrieve numerous patient records into or from the system 10, as shown in steps 56 and 60, respectively. In addition, a physician can upload color topography maps, diagnostic ocular scans, photos, images and visual fields associated with or relevant to the needs of the patient.

A calculation page 96 is also provided, whereby a patient or physician can make various calculations using a patient's record information. In one embodiment, the physician chooses formulas which are to be used in the calculation of patient surgical or other treatment parameters based upon the patient's data. In one embodiment, the physician enters the formula s which are to be used in the calculations. In another embodiment, the physician selects from formulas which are presented in a menu fashion. For example, the physician may enter a calculation page which allows him or her to choose formulas such that the application is preloaded with a formula of the physician's choosing. In yet another embodiment, the physician can make use of formulas known in the art, or the physician can customize known formulas as appropriate for the physician, the available equipment, or the optical details of the patient. Furthermore, the physician can maintain the privacy of the formulas, or the physician can choose to share them via a sharing function. The physician can enter a preferred formula such as one known in the art, or create one on the website. The physician can choose to keep original formulas private or make them available to other physicians enrolled in the website. Currently, there are over a dozen formulas available to physicians. Most cataract surgeons use as many formulas as possible (based on the available information/data) and look either for a trend an average or take the highest IOL power recommended. There really is no consensus in this area. With regard to how formulas are programmed, variables are assigned to each of the data points entered into the database and operators such as, for example, +, −, /, etc., are used to create individual formulas. A check box can allow the surgeon to share or not to share his or her particular formula.

It is therefore intended that the foregoing detailed description be regarded as illustrative rather than limiting, and that it be understood that it is the following claims, including all equivalents, that are intended to define the spirit and scope of this invention.

### BRIEF DESCRIPTION OF THE DRAWINGS

The details of the invention, both as to its structure and operation, may be obtained by a review of the accompanying drawings, in which like reference numerals refer to like parts, and in which:

FIG. 1 is a flow diagram of one embodiment of the present invention; and

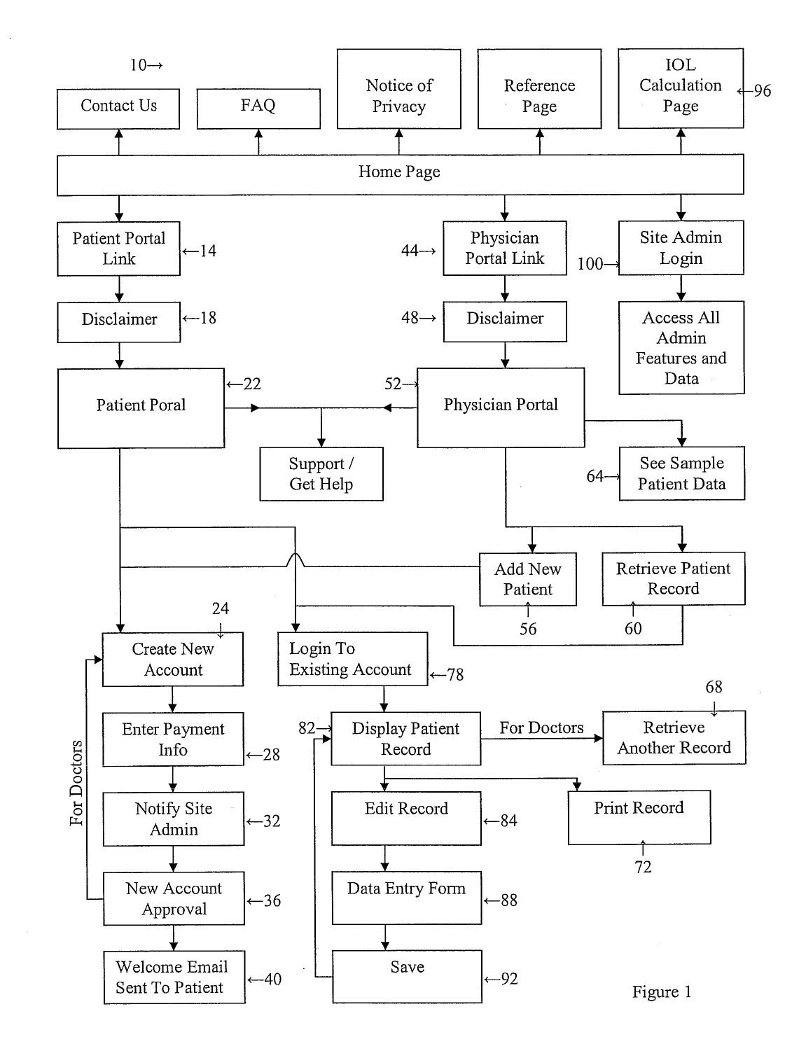

FIG. 2 illustrates a sample record collection form according to one embodiment of the present invention.

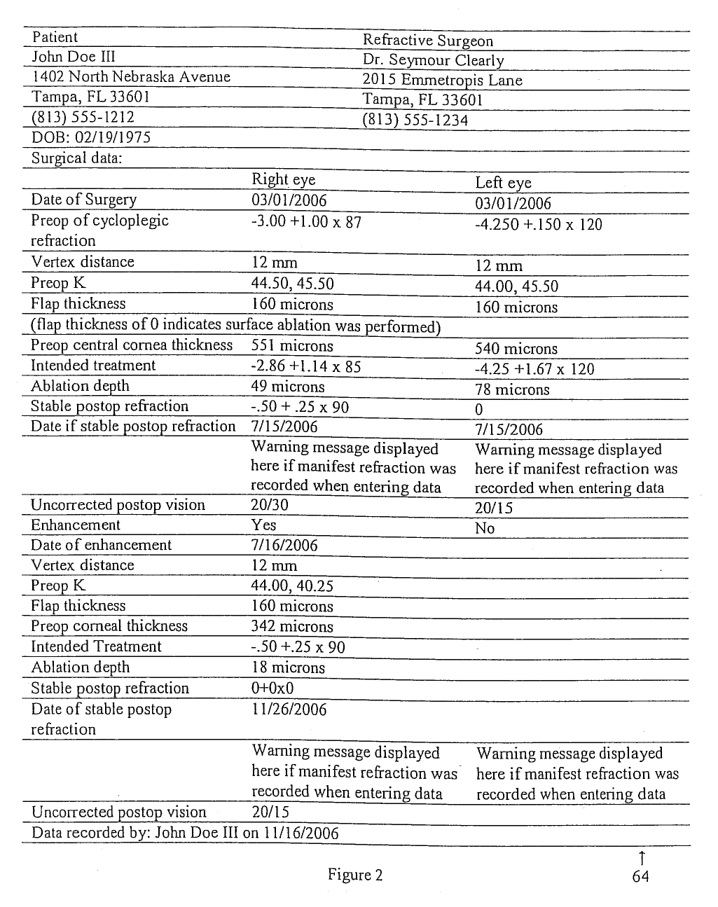

### DETAILED DESCRIPTION

The invention is described with reference to the drawings. The relationship and functioning of the various elements of this invention are better understood by the following detailed description. However, the embodiments of this invention as described below are by way of example only, and the invention is not limited to the embodiments illustrated in the drawings. Furthermore, in certain instances, details which are not necessary for an understanding of the present invention, such as conventional details of fabrication and assembly, have been omitted.

The present invention comprises a web based ocular information management system comprising an introductory page or “home page” which optionally comprises introductory information such as, for non-limiting example, an explanation of the services provided therein, an elucidation of the problems associated with a lack of availability of measurements from cornea refractive surgeries, and the need to have the measurements available in order to, among other things, 1) interpret the results from pressure measurements performed in glaucoma screening or for other purposes, and 2) calculate the parameters of an IOL to be implanted during cataract surgery. Other information to be optionally included in the introductory page is a site directory, a statement of fees in order to use the services provided therein, or other introductory material which explains the necessity of the services, and the advantages provided by them.

The home page links to several series of linked pages, two of which are portals for site users. One is generally accessed by a patient, and the other is generally accessed by those to whom the patient permits access.

The Patient

The patient portal is the first page in the patient series. The patient portal page can comprise a welcome message, as well as a link to a page containing a disclaimer page. The disclaimer page which asks the patient to agree to certain conditions as a precedent to using the service. Such disclaimer language can be general legal type disclaimers, such as the assent to or acknowledgement of having read certain statements. For example, the page can elucidate the degree of privacy provided by the site with respect to the sharing of patient information, including the patient's physician, under circumstances such as medical emergency, imprisonment of the patient, and the like.

The disclaimer page may include statements that patient data entered into the site is or is not verified for accuracy. For instance, in one embodiment, the information managed by the service includes the patient's preoperative curvature measurements, surgical correction and postoperative measurements and the disclaimer page indicates that the site does not guarantee that the data entered by the user is accurate and true. The final decision to use the information rests with the physician utilizing the service to perform postoperative calculations.

In other embodiments, the disclaimer page asks for verification that it has been read by the patient. In one embodiment, the patient verifies by clicking to the next page, the patient portal. In another embodiment, a separate act is required for verification, such as scrolling over or clicking on a separate icon, which may, if desired, become operational only after the patient has scrolled through the disclaimer section.

The disclaimer page is linked to the patient portal page, which links to a “create new account” page giving the opportunity to create a new account and a “log in” page inviting to log in to an already existing account. If a patient is creating a new account, the “create new account” page is selected. In one embodiment, a new account is established by providing a valid e-mail address, selecting a password, and having it mailed to the e-mail address. In another embodiment, the patient is subjected to more stringent measures such that the patient's identity can be ascertained to a greater degree of certainty. Such measures can include verification through microdeposit via an online secure payment method such as “PayPal” or the like.

In some embodiments, the patient creates an account by registering with the site by establishing or confirming identity. In such cases, the information could be, among other things, billing-type information, such a credit card number, a bank account number, or the like. In another embodiment, the identity of the patient is verified through an online identity verification system. For instance, one or more micro deposits could be made by the system into the patient's bank account through a service such as “PayPal,” at which point the patient could register upon verification of deposit details, such as the deposit amount.

The patient can signify access to a given individual in a number of ways. In one embodiment, the patient information is password-protected, and the patient gives access to the medical professional by communicating the password. In another embodiment, the patient's password is the patient's social security number, or other piece of private information which may be requested by a doctor's office, such that the patient's physician would have legitimate familiarity. The information could be personal, such as the answer to a question that, in general, only one designated by the patient would know. In embodiments in which the physician demonstrates legitimacy of access through entering information gained from the patient, the patient enters and stores the information beforehand. In other embodiments, the patient identifies the accessor, and the accessor establishes identity by entering identifying information which is identical to, or consistent with identifying information entered by the patient. In another embodiment, a physician can search the database for a patient. Once the patient is located within the database, the physician can send a request to the patient for access to the patient's information. In another embodiment, the physician designates a patient for whom access is sought, and the site sends an email or other notification to the patient that a given physician seeks access. The request for information may be within the site, such that if the patient logs into the site, the patient will receive a notice, such as associated with the account, that the physician requests access. The patient may approve or deny the request. In another embodiment, either by the physician or the system emails the request to the patient, who then logs onto the website and either approves or denies the request. At any time, access previously approved may be revoked by the patient.

As with patient registration, in some embodiments, the patient or the site makes one or more microdeposits via an online payment system into the account of the designated accessor, at which point the accessor verifies identity by confirming deposit details such as amount. The accessor then has access to the patient data. In another embodiment, the information is accessible only to ophthalmologists or other eye specialists who are licensed, and who enter professional information which can be verified as true, as well as consistent with the conditions of access given by the patient. It is preferable that the means for giving access, as well as the process of accessing the information is secure.

The term “physician” is interpreted to include medical professionals designated by the patient as designated accessors and can include physicians, ophthalmologists, optometrists, assisting personnel such as nurses technologists, physician's assistants and the like, or other medical professionals which are permitted by the patient to access the information. In one embodiment, confirmation of a physician's credentials may be requested by the patient and confirmed by comparing the physician's license number to an online database of licensed physicians.

In one embodiment, the patient portal, the disclaimer page, or the patient portal link also link to a “support” or “help” page which can contain frequently answered questions (“FAQs”) or other means of addressing issues which arise 1) when a patient is deciding whether or not to use the service, or 2) when a patient is attempting to use the service.

A patient creating a new account, will choose the “create new account” page which will either direct the patient to enter payment information or direct the patient to a page, preferably secure, which can accept payment information. In different embodiments, the payment information can be credit card or bank account numbers sufficient to uniquely identify the account to be drafted or charged. Payment information is then approved or confirmed. In separate embodiments, the patient enters information which can be used in the identification and verification of a legitimate accessor at a times prior to, during and after the “create new account” page.

In an embodiment, the process of creating a new account comprises an approval by the site administration. This approval comprises notification of the site administration at some time in the account creation, as well as subsequent affirmation to the patient. The notification step can occur upon the provision by the patient of identifying information (in the least stringent embodiment, the provision of a valid e-mail address) or upon later steps of new account creation, such as the entry, confirmation or verification of payment information. The new account approval can occur at the above identified parts of the process, provided it is subsequent to the notification step. In an embodiment, additional information is required of the patient at any of the steps prior to new account approval, and in an embodiment prior to notification. Such additional information can include, for example, a request for certain items of medical history, credit history, permission to access medical records, and the like.

Once a new account has been approved, in an embodiment, the patient is welcomed, such as with a screen greeting and/or an email to a patient email address.

Once the patient has logged into an existing account or created a new account, the patient is directed to a “display patient record” page which displays or links to a page which displays patient data. In one embodiment, the page already contains the patient data, having previously been entered by the patient or physician. In another embodiment, the page is either partially populated, or unpopulated with data.

In one embodiment, the data display is read only. In another embodiment, the data display is editable by the patient, such that the data can be corrected or completed. In one embodiment, the “display patient record” page links to an “edit record page” which links to a “data entry form” which can be edited or partially or fully populated with data by the patient. Once the data is entered, it is saved to the system, either by leaving the page, or by clicking on an icon.

The Physician

The home page also links to a physician portal link, which is the first page in a series of linked pages designed to allow the medical professional seeking access to data stored with the service (“accessor”) to view the data.

As with the patient portal link, the physician portal link can comprise a welcome message, as well as a link to a page comprising disclaimer information. The disclaimer page asks the physician to agree to certain conditions as a precedent to using the service. Such disclaimer language can be general legal disclaimers, such as the assent to or acknowledgement of having read certain statements. For example, the page can elucidate the degree of privacy provided by the site with respect to the sharing of patient information, including the patient's physician, under circumstances such as medical emergency, imprisonment of the patient, and the like. As another example, the disclaimer page may include statements that patient data entered into the site is not verified for internal consistency. For instance, it is possible that the information managed by the service includes data which normally must be accurate and have a degree of internal consistency. In one embodiment, the information retained and managed includes the patient's preoperative curvature measurements, surgical correction and postoperative measurements, and the disclaimer page indicates that the site does not guarantee that the data entered by the user is accurate and true.

In other embodiments, the disclaimer page asks for verification that it has been read by the physician. In one embodiment, the physician verifies by clicking to the next page, the physician portal. In another embodiment, a separate act is required for verification, such as scrolling over or clicking on a separate icon, which may, if desired, become operational only after the patient has scrolled through the disclaimer section.

The disclaimer page is linked to the physician portal page, which links to a “log in” page, and optionally a “create new account” page or the like which is to be accessed if the physician is visiting the site for the first time. In one embodiment, the physician accesses a page which requires that the physician input information, such as for example, a password, identifying the physician as one to whom the patient has granted access. In another embodiment, the physician registers with the site by inputting data which uniquely identifies the physician. In one embodiment, physician identity is confirmed when the physician inputs information which is compared against information which has been entered by the patient. In another embodiment the physician inputs information which establishes an identity 1) as a physician and 2) as one to whom the patient has granted access. Thus more would be required than simply inputting a password of significance with respect to the patient.

In one embodiment, the physician is required to create an account with the service. In such a case, the physician portal links to a “create new account” page. In one embodiment, a new account is established by providing a valid e-mail address, selecting a password, and having it mailed to the e-mail address. In another embodiment, the physician is subjected to more stringent measures such that the physician's identity can be ascertained to a greater degree of certainty. Such measures can include verification of identity through microdeposit via an online secure payment method such as “PayPal” or the like, coupled with a verification of address of practice, for example. In additional embodiments, the physician verifies identity by entering information, such as medical license number and/or work or home address, and the information is confirmed with one or more medical licensure boards.

In one embodiment, the physician portal link, the disclaimer page, or the physician portal also link to a “support” or “help” page which can contain frequently answered questions (“FAQs”) or other means of addressing issues which arise 1) when a physician is deciding whether or not to use the service, or 2) when a physician is attempting to use the service.

In one embodiment, the physician registers with the system or is otherwise identifiably retained by the system and the physician portal links to an intervening link, an “add new patient” screen, which links to the “create new account” screen. This intervening screen optionally tracks the number and/or identities of the patients associated with a given physician, and links to the “create new account” screen to enable the physician to establish an association with another patient. Once a physician logs into the website, he/she will be able to create new patient accounts.

Once the physician has entered the registration information at the “create new account” page, the physician submits the information by, for example, linking to a “new account approval page,” and the submitted information is verified against the patient's verifying information. In one embodiment, the physician enters verification information upon registering, and “new account approval is contingent upon the information being consistent with the patient's verifying information.

In another embodiment, the physician portal is linked to an intervening “retrieve patient data” screen, which links to the “log-into existing account” screen.

In another embodiment, the physician does not register or create an account by entering self-identifying information, but accesses patient data by entering information which is, in two separate embodiments, identical to (for example, a password) or consistent with (for example, the answer to a question) information entered by the patient and indicated as pertinent to establishing the legitimacy of the accessor.

Once the physician has logged into an existing account or created a new account, the physician is directed to a “display patient record” page which displays or links to a page which displays patient data. In one embodiment, the page already contains the patient data, having previously been entered by the physician or patient. In another embodiment, the page is either partially populated, or unpopulated with data.

In one embodiment, the data display is read only. In another embodiment, the data display is editable by the physician, such that the data can be corrected or completed. In one embodiment, the “display patient record” page links to an “edit record page” which links to a “data entry form” which can be edited or partially or fully populated with data by the physician. Once the data is entered, it is saved to the system, by methods such as leaving the page, or clicking on an icon.

In one embodiment, if a physician has accessed the data, and the physician is the designated accessor for multiple patients, the “display patient record” page links to a “retrieve another record page,” which gives the physician an opportunity to access the data of another patient.

In a preferred embodiments, the physician either 1) creates a new account for each patient, or 2) creates one account, but is required to enter information verifying the physician's identity as a designated accessor. Thus, at the “retrieve another record” page, the physician accesses the data for a second patient by either 1) logging into the physician account associated with the patient, or 2) in another embodiment, entering information that verifies that the physician is a designated accessor for the patient.

Data that can be stored generally comprises information related to variables associated with the shape and thickness of the cornea, lens or retina.

Data to be stored can comprise ocular data comprising ocular parameters or information descriptive thereof. Such ocular parameters or information descriptive thereof can comprise one or more of distances, curvatures or thicknesses of the cornea, said data comprising one or more of the following: the curvature of the cornea; the thickness of the cornea; distance from one or more points on the innermost surface, outermost surface or inner volume of the cornea to one or more points on the near surface, the far surface or inner volume of the lens; distance from lens to retina; distance from one or more points on the innermost surface, outermost surface or inner volume of the cornea to one or more points on the retina; the distance from one or more points on the near surface, the far surface or inner volume of the lens to one or more points on the retina; the distance from one or more points on the innermost surface, outermost surface or inner volume of the cornea to one or more points on the retina.

Data stored can also comprise type or other characteristics relating to the laser, if any, used to perform the refractive surgery. For example, the data can comprise laser medium, frequency/wavelength spectrum of radiation used, pulse frequency spectrum, frequency and duration of pulse. The date can comprise the type of laser treatment, such as whether laser is wavefront-guided, wavefront-assisted, wavefront-optimized, intrastromal or standard treatment.

The data can comprise the software platform, such as that used in operating and/or guiding the laser during the operation; details with respect to the type of operation, such as LASIK, surface ablation (PRK) or other. The data can comprise preoperative IOP measurements, baseline postoperative measurements, operating room parameters, such as, for example, temperature and humidity; pre-refractive surgery optimal IOL parameters; date(s) of surgery, location(s) of surgery, follow up care, and dates of other successive operations or events; pre-operative cycloplegic refraction; vertex distance; preoperative K values; post-operative K values; flap thickness; preoperative cornea thickness; inlay size, inlay thickness and inlay material; type of intended treatment and successive treatments and procedures; ablation depth; stable post-operative cycloplegic refraction; date of post-operative refraction measurement; uncorrected post-operative vision; hyperopic CK or astigmatic CK; CK # spots and location; CK optical zone; and other data pertaining to or relevant to aiding an optical professional in the correction of vision via cornea refractive methods; and the like.

In an embodiment, the physician can cause data to be entered into the website directly from an excimer laser used in a cornea refractive procedure. The data can comprise, among other things, position settings, intensity, pulse spectrum and timelength, and other laser variables relevant to the procedure, as well as their variance, if any, with time throughout the procedure. In one embodiment, data can be entered into the site directly from an excimer laser during a cornea refractive surgery operation. In one embodiment, the data is entered in real time. In another embodiment, such data is entered into the site at a time prior to or after the procedure.

In another embodiment, the website has the capability of exporting physician data to outcome analysis software. The physician outcomes analysis software (OAS) can analyze a specific physician surgical results. For example, it can takes the intended correction and compare it with the actual postop outcome and create a nomogram which the surgeon can use to modify treatments on future patients. For example if all patients that have a prescription −3.00 and receive a −3.00 treatment but they actually end up (stable postop refraction)−0.30 instead of 0.00 the OAS can recommend that the surgeon add −0.30 treatment on future patients to achieve a postop refraction of 0.00. The website can serve as a source of information/data for the OAS for a specific surgeon or even a specific laser platform.

In yet another embodiment, the system comprises a software module which can, from a given patient's data set, assess the likelihood of a given surgical result when beginning with a given set of surgical parameters (laser parameters and the like). The module analysis can take into account the empirical results associated with the use of a particular surgical laser in the prediction of probable surgical outcome, and provide nomograms for greater vision improvement by a procedure, as well as greater accuracy and precision of laser treatment.

Data can also include information pertaining to the operation of the web-based method, such as the date of patient sign up, the date of physician sign up; the date of access request, the date of access grant; and the like.

The data can comprise one or more of the following: types of surgery performed on the eye prior to the time of entry in a), and parameters associated with said surgeries; and changes in ocular parameters or information descriptive thereof, due to cornea refractive surgery.

The system optionally comprises an IOL and IOP calculator which utilizes the stored patient data to calculate the parameters of the IOL and IOP. In one embodiment, the IOL and IOP calculator is linked to the home page. In additional embodiments, the IOL and IOP calculator can automatically retrieve all the data of an identified patient and calculate the IOL and IOP parameters. In other embodiments, the calculator is linked to a page which asks for the necessary data, and into which the data can be entered. In one embodiment, the system is can export data from a patient's file into a separate spreadsheet to perform calculations pertaining to IOL or IOP values, actual, optimal or other; or into another such calculator located at another website.

The system optionally comprises a “contact us” page comprising administrative contact information and/or a “help line;” a “frequently asked question” page, a “notice of privacy” page, and/or a “reference page.” In particular, the reference page can comprise information or articles related to optical surgery types and their theory of effectiveness, shortcomings, etc.

The management system can have the following additional functions:

1. Ability of patient to electronically signed Release of Information at doctors office to allow instant transfer of information. This insures HIPAA compliance (SYS).

2. Accept data transfer from other online electronic medical records (EMRs) for the seamless transfer of information from different ophthalmologists own EMR into SYS.

3. Eye banks (organizations that harvest, store and supply cornea tissue for corneal transplants) can use the website to help screen donors for previous refractive surgery. Corneas that have had LASIK may not be appropriate to use for cornea transplants.

4. Calculate post-refractive IOL power by subtracting corrected (spherical equivalent) refraction from prerefractive surgery optimal IOL power

This is another way to adjust the IOL power for patients undergoing cataract surgery after cornea refractive surgery. Before cornea refractive surgery is performed the eye can be measured for an IOL as if they were going to have cataract surgery. The IOL power can be recorded, modified and stored for later use.

What is claimed is:

1) A method for managing ophthalmic information, said method comprising the steps of:
a) entering and storing data into a web-based management system at a first time;
b) enabling a designated accessor to access the data;
c) accessing and displaying the data in b) at a first time;
d) performing ophthalmic surgery at a second time after said first time, in reliance on ocular data accessed in c).

2) A method as in claim 1 wherein the data comprises one or more data of one or more of the following data types:
ocular data comprising ocular parameters or information descriptive thereof, comprising one or more of distances, curvatures or thicknesses of the cornea, lens and/or retina, said data comprising one or more of the following: the curvature of the cornea; the thickness of the cornea; distance from one or more points on the innermost surface, outermost surface or inner volume of the cornea to one or more points on the near surface, the far surface or inner volume of the lens; distance from lens to retina; distance from one or more points on the innermost surface, outermost surface or inner volume of the cornea to one or more points on the retina; the distance from one or more points on the near surface, the far surface or inner volume of the lens to one or more points on the retina; the distance from one or more points on the innermost surface, outermost surface or inner volume of the cornea to one or more points on the retina;
characteristics relating to the laser used to perform the refractive surgery comprising laser medium, frequency/wavelength spectrum of radiation used, pulse frequency spectrum, frequency and duration of pulse; whether laser is wavefront-guided, wavefront-assisted, wavefront-optimized, intrastromal or standard treatment; the software platform used in operating and/or guiding the laser during the operation; whether the type of operation is LASIK, surface ablation (PRK) or other; preoperative IOP measurements, baseline postoperative measurements; operating room temperature and humidity; pre-refractive surgery optimal IOL parameters; date(s) of surgery, location(s) of surgery, follow up care, and dates of other successive operations or events; pre-operative cycloplegic refraction; vertex distance; preoperative K values; post-operative K values; flap thickness; preoperative cornea thickness; inlay size, inlay thickness and inlay material; type of intended treatment and successive treatments and procedures; ablation depth; stable post-operative cycloplegic refraction; date of post-operative refraction measurement; uncorrected post-operative vision; hyperopic CK or astigmatic CK; CK # spots and location; CK optical zone; and other data pertaining to or relevant to aiding an optical professional in the correction of vision via cornea refractive methods; and the like.

3) A method as in claim 1 wherein the data comprises one or more of the following: types of surgery performed on the eye prior to the time of entry in a), and parameters associated with said surgeries.

4) A method as in claim 1 wherein the data comprises changes in ocular parameters or information descriptive thereof, due to a corneal refractive surgery.

5) A method as in claim 1 wherein the data in a) is entered by the patient.

6) A method as in claim 1 wherein the data in a) is entered by a physician.

7) A method as in claim 1 wherein the data in a) is entered by a first physician and accessed by a second physician in c).

8) A method as in claim 1 wherein the enablement in b) comprises the storing of a password with the system and the provision of the password to an accessor.

9) A method as in claim 1 wherein the enablement in b) comprises the storing of accessor-identifying information with the system and the confirmation of accessor identity through verification of accessor-provided identifying information.

10) A method as in claim 1 wherein the ophthalmic surgery in d) comprises the replacement of a natural lens with an IOL.

11) A method as in claim 10 wherein said IOL has IOL parameters calculated from data comprising the data accessed in c).

12) A method as in claim 1 wherein the designated accessor performs the cornea refractive surgery in d).

13) A method as in claim 1 wherein the ocular data in a) comprises cornea refractive surgery ocular measurements.

14) A method as in claim 13 wherein the ocular data in a) additionally comprises post-cornea refractive surgery ocular measurements, or differences in measurements due to surgery.

15) A method as in claim 14 wherein said later surgery is performed in reliance upon the data accessed in c).
